(19) United States
(12) Patent Application Publication
(10) Pub. No.: US 2024/0412258 A1
(43) Pub. Date: Dec. 12, 2024

(54) ADVERTISEMENT SYSTEM USING DOORBELL AND METHOD THEREOF

(71) Applicant: COMMAX CO., LTD., Seongnam-si (KR)

(72) Inventor: Min Su LEE, Seongnam-si (KR)

(73) Assignee: COMMAX CO., LTD., Seongnam-si (KR)

(21) Appl. No.: 18/366,996

(22) Filed: Aug. 8, 2023

(30) Foreign Application Priority Data
Jun. 8, 2023 (KR) 10-2023-0073598

(51) Int. Cl. G06Q 30/0251; G06Q 30/0207; G06Q 30/0242; H04N 7/18

(52) U.S. Cl. CPC G06Q 30/0271; G06Q 30/0207; G06Q 30/0243; H04N 7/186

(57) ABSTRACT

Disclosed are an advertisement system and method. More particularly, an advertisement system using a doorbell, the advertisement system including: a data collector configured to collect video data of a visitor corresponding to a call message when the call message is received from a doorbell; a context extractor configured to extract context information through impression analysis based on the collected image data; an advertisement extractor configured to extract at least one customized advertisement from among a plurality of pre-stored advertisements based on the extracted context information; and an advertisement provider configured to control the extracted customized advertisement to be displayed to the visitor through the doorbell is disclosed.

### CROSS-REFERENCE TO RELATED APPLICATION

This application claims the priority benefit of Korean Patent Application No. 10-2023-0073598, filed on Jun. 8, 2023, in the Korean Intellectual Property Office, the disclosure of each of which is incorporated herein by reference.

### BACKGROUND OF THE DISCLOSURE

### Field of the Disclosure

The present disclosure relates to an advertisement system using a doorbell and a method thereof, and more particularly to a technical idea of playing an advertisement using a doorbell and providing a corresponding reward.

In addition, the present disclosure was derived from research conducted as part of the World Class Plus project (project identification number: 1415176290, department name: Ministry of Trade, Industry and Energy, project management (specialized) institution: Korea Institute for Advancement of Technology, research period: Apr. 1, 2021 to Dec. 31, 2023).

### Description of the Related Art

The Internet is evolving from a human-centered connection network in which humans create and consume information to an Internet of Things (IoT) network in which information is exchanged and processed between distributed components such as objects. In particular, Internet of Everything (IoE) technology, in which IoT technology is combined with big data processing technology through connection with a cloud server, etc., is also emerging. To implement IoT, technical elements such as sensing technology, wired/wireless communication and network infrastructure, service interface technology, and security technology are required, and recently, a sensor network, Machine to Machine (M2M), Machine Type Communication (MTC) for connection between objects, etc. are also being actively researched.

In the IoT environment, intelligent IT (Internet Technology) services that create new values in human life by collecting and analyzing data generated from connected objects can be provided. IoT is being applied to the field of smart homes, smart buildings, smart cities, smart cars or connected cars, smart grids, health care, smart home appliance, advanced medical service, etc. through convergence and integration between existing Information Technology (IT) technology and various industries.

In particular, a technology that provides advertisement services to consumers, such as residents or visitors, through interworking with the Internet network is attracting attention in a smart home environment.

Specifically, there are currently various advertising services using media such as the Internet and TV, and advertising services based on a smart home environment can actively induce product purchases by providing coupon and discount information to consumers, thereby receiving a lot of attention from advertisers.

However, existing smart home-based advertising services have a problem in that the ratio of inducing actual product consumption is not high because generally registered advertisements are output instead of consumer-tailored advertisements.

### RELATED ART DOCUMENT

### Patent Document

Korean Patent Application Publication No. 10-2016-0149849, “APPARATUS AND METHOD FOR PROVIDING ADVERTISEMENT SERVICE IN WIRELESS COMMUNICATION SYSTEM”

### SUMMARY OF THE DISCLOSURE

Therefore, the present disclosure has been made in view of the above problems, and it is an object of the present disclosure to provide an advertisement system for and method of providing customized advertisements to visitors using a doorbell.

It is another object of the present disclosure to provide an advertisement system for and method of enabling a resident to generate a certain amount of revenue by providing the resident with a reward according to the output of a customized advertisement in the form of a point.

It is yet another object of the present disclosure to provide an advertisement system and method that can increase the probability of actual product purchase by a visitor by providing a customized advertisement through analysis of a visitor' impression.

In accordance with an aspect of the present disclosure, the above and other objects can be accomplished by the provision of an advertisement system using a doorbell, the advertisement system including: a data collector configured to collect video data of a visitor corresponding to a call message when the call message is received from a doorbell; a context extractor configured to extract context information through impression analysis based on the collected image data; an advertisement extractor configured to extract at least one customized advertisement from among a plurality of pre-stored advertisements based on the extracted context information; and an advertisement provider configured to control the extracted customized advertisement to be displayed to the visitor through the doorbell.

In accordance with an aspect, the advertisement system may further include a reward provider configured to accumulate a reward corresponding to the outputted customized advertisement to a preset account of a resident who received the call message.

In accordance with an aspect, the reward provider may measure a time from a time point at which the customized advertisement is played through the doorbell to a time point at which the play ends, and accumulate the number of points corresponding to the measured time as a reward.

In accordance with an aspect, the context extractor may extract at least one piece of information of gender information, age information, costume-wearing information, accessory-wearing information, and height information of the visitor as the context information.

In accordance with an aspect, the advertisement extractor may calculate a context match rate between pre-stored category information corresponding to each of the plural advertisements and the extracted context information, and extract one of the plural advertisements as the customized advertisement based on the calculated context match rate.

In accordance with an aspect, the advertisement extractor may extract one advertisement as the customized advertisement based on the context match rate and the advertisement cost information of each of the plural advertisements.

In accordance with an aspect, when there are two or more advertisements whose context match rate exceeds a preset threshold among a plurality of advertisements, the advertisement extractor may extract one advertisement with a highest advertisement rate among the two or more advertisements as the customized advertisement.

In accordance with another aspect of the present disclosure, there is provided an advertisement method using a doorbell, the advertisement method including: by a data collector, collecting video data of a visitor corresponding to a call message when the call message is received from a doorbell; by a context extractor, extracting context information through impression analysis based on the collected image data; by an advertisement extractor, extracting at least one customized advertisement from among a plurality of pre-stored advertisements based on the extracted context information; and by an advertisement provider, controlling the extracted customized advertisement to be displayed to the visitor through the doorbell.

In accordance with an aspect, the advertisement method may further include, by a reward provider, accumulating a reward corresponding to the outputted customized advertisement to a preset account of a user who received the call message.

In accordance with an aspect, by the advertisement extractor in the extracting of the at least one customized advertisement, a context match rate between pre-stored category information corresponding to each of the plural advertisements and the extracted context information may be calculated, and one of the plural advertisements may be extracted as the customized advertisement based on the calculated context match rate.

In accordance with an aspect, by the advertisement extractor in the extracting of the customized advertisement, one advertisement may be extracted as the customized advertisement based on the context match rate and the advertisement cost information of each of the plural advertisements.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a drawing for explaining an advertisement system according to an embodiment;

FIG. 2 is a drawing for more specifically explaining the advertisement system according to an embodiment; and

FIG. 3 is a drawing for explaining an advertisement method according to an embodiment.

### DETAILED DESCRIPTION OF THE DISCLOSURE

The embodiments will be described in detail herein with reference to the drawings.

However, it should be understood that the present disclosure is not limited to the embodiments according to the concept of the present disclosure, but includes changes, equivalents, or alternatives falling within the spirit and scope of the present disclosure.

In the following description of the present disclosure, a detailed description of known functions and configurations incorporated herein will be omitted when it may make the subject matter of the present disclosure unclear.

The terms used in the specification are defined in consideration of functions used in the present disclosure, and can be changed according to the intent or conventionally used methods of clients, operators, and users. Accordingly, definitions of the terms should be understood on the basis of the entire description of the present specification.

In description of the drawings, like reference numerals may be used for similar elements.

The singular expressions in the present specification may encompass plural expressions unless clearly specified otherwise in context.

In this specification, expressions such as “A or B” and “at least one of A and/or B” may include all possible combinations of the items listed together.

Expressions such as “first” and “second” may be used to qualify the elements irrespective of order or importance, and are used to distinguish one element from another and do not limit the elements.

It will be understood that when an element (e.g., first) is referred to as being “connected to” or “coupled to” another element (e.g., second), it may be directly connected or coupled to the other element or an intervening element (e.g., third) may be present.

As used herein, “configured to” may be used interchangeably with, for example, “suitable for”, “ability to”, “changed to”, “made to”, “capable of”, or “designed to” in terms of hardware or software.

In some situations, the expression “device configured to” may mean that the device “may do˜” with other devices or components.

For example, in the sentence “processor configured to perform A, B, and C”, the processor may refer to a general purpose processor (e.g., CPU or application processor) capable of performing corresponding operation by running a dedicated processor (e.g., embedded processor) for performing the corresponding operation, or one or more software programs stored in a memory device.

In addition, the expression “or” means “inclusive or” rather than “exclusive or.”

That is, unless otherwise mentioned or clearly inferred from context, the expression “x uses a or b” means any one of natural inclusive permutations.

In the above-described specific embodiments, elements included in the disclosure are expressed singular or plural in accordance with the specific embodiments shown.

It should be understood, however, that the singular or plural representations are to be chosen as appropriate to the situation presented for the purpose of description and that the above-described embodiments are not limited to the singular or plural constituent elements. The constituent elements expressed in plural may be composed of a single number, and constituent elements expressed in singular form may be composed of a plurality of elements.

In addition, the present disclosure has been described with reference to exemplary embodiments, but it should be understood that various modifications may be made without departing from the scope of the present disclosure.

Therefore, the scope of the present disclosure should not be limited by the embodiments, but should be determined by the following claims and equivalents to the following claims.

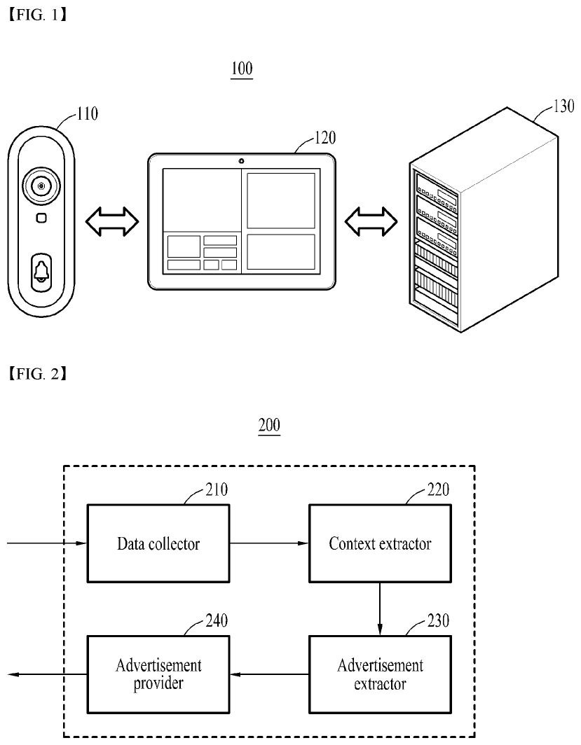

FIG. 1 is a drawing for explaining an advertisement system according to an embodiment.

Referring to FIG. 1, an advertisement system 100 according to an embodiment can provide a customized advertisement to a visitor using a doorbell.

In addition, the advertisement system 100 provides a reward according to an output of a customized advertisement to a resident in the form of a point so that the resident can generate a certain amount of revenue.

In addition, the advertisement system 100 may increase the probability that a visitor actually purchases a product by providing a customized advertisement through analysis of a visitor's impression.

For this, the advertisement system 100 may include a doorbell 110, a wall pad 120 and a cloud server 130.

The doorbell 110 according to an embodiment may provide a visitor's image data to a resident's wall pad 120 together with a call message when a visitor presses a call button corresponding to a resident's residence.

For example, the doorbell 110 may be installed in correspondence with at least one of a common entrance and lobby of a building where a resident resides and a front door of a resident's residence, and may be connected to the wall pad 120 through wired or wireless Internet.

In addition, the image data may be real-time image data of a visitor collected from the time the visitor presses a call button.

The wall pad 120 according to an embodiment may extract context information through impression analysis based on image data and transmit the extracted context information to the cloud server 130.

The cloud server 130 according to an embodiment may extract a customized advertisement based on the extracted context information, and feedback the extracted customized advertisement to the wall pad 120 so that the doorbell 110 may output (i.e., play) the advertisement.

For example, the customized advertisement may be at least one of a video advertisement and a voice advertisement.

That is, the advertisement system 100 may control a customized advertisement corresponding to a visitor's impression to be played in real-time when a visitor presses a doorbell so that the visitor watches the advertisement while waiting. In other words, the advertisement system 100 may replace the sound of the doorbell with an advertisement and provide it to the visitor.

More specifically, the wall pad 120 may receive an advertisement ID of a customized advertisement selected from the cloud server 130, perform advertisement streaming from the cloud server 130 based on the received advertisement ID, and, at the same time, connect the doorbell 110 with an advertisement communication channel and play an advertisement streamed to the channel.

Here, the doorbell 110 transmits a streamed advertisement instead of a basic ring tone (i.e., a ring tone) from a chipset, and, when a resident receives a call from the wall pad 120, the transmitted advertisement streaming is stopped and a communication channel with the resident is connected.

Meanwhile, the cloud server 130 may control a reward corresponding to an advertisement that is output through the doorbell 110 to be accumulated in a preset account of a resident corresponding to a residence where the wall pad 120 is installed.

Specifically, the cloud server 130 may measure the time from when a customized advertisement is played through a doorbell to the time when playback ends, accumulate the number of points corresponding to the measured time to a resident's account as a reward, and control the accumulated reward and a summed reward to be output through the wall pad 120.

That is, a resident may earn advertisement revenue due to the act of a visitor pressing the doorbell 110 and watching the advertisement without the resident needing to watch the advertisement.

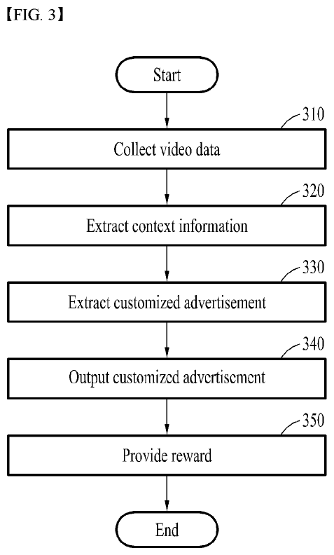

The advertisement system 100 according to an embodiment will be described in more detail with reference to FIG. 2.

FIG. 2 is a drawing for more specifically explaining the advertisement system according to an embodiment.

Referring to FIG. 2, an advertisement system 200 according to an embodiment may include a data collector 210, a context extractor 220, an advertisement extractor 230 and an advertisement provider 240.

For example, the data collector 210, the context extractor 220 and the advertisement provider 240 may be included in the wall pad 120 described with reference to FIG. 1, and the advertisement extractor 230 may be included in the cloud server 130 described with reference to FIG. 1.

The data collector 210 according to an embodiment may collect video data of a visitor corresponding to a call message when the call message is received from a doorbell.

The context extractor 220 according to an embodiment may extract context information through impression analysis based on the collected image data.

In accordance with an aspect, the context extractor 220 may extract at least one piece of information of visitor's gender information, age information, costume-wearing information, accessory-wearing information, and height information as the context information.

For example, the context extractor 220 may determine age information (e.g., 10s, 20s, 30s, etc.) of a visitor based on a preset age determination algorithm that receives collected image data as an input.

In addition, the context extractor 220 may determine visitor's gender information (e.g., male or female), costume-wearing information (e.g., suit, casual, etc.), accessory-wearing information (e.g., earrings, necklace, glasses, etc.) and height information (e.g., short and tall, etc.) based on a preset impression discrimination algorithm that receives collected image data as an input.

In addition, the context extractor 220 may extract appearance information (e.g., hairstyle, mustache, etc.) as context information based on a preset impression discrimination algorithm that receives collected image data as an input.

The advertisement extractor 230 according to an embodiment may extract at least one customized advertisement from among a plurality of pre-stored advertisements based on the extracted context information.

In accordance with an aspect, the advertisement extractor 230 may calculate a context match rate between pre-stored category information corresponding to each of the plural advertisements and the extracted context information, and extract one of the plural advertisements as the customized advertisement based on the calculated context match rate.

For example, the advertisement extractor 230 may collect category information and advertisement cost information corresponding to advertisements from companies registering advertisements in advance and register them together with advertisements.

As a more specific example, the advertisement extractor 230 may register category information of a company that sells men's basketball shoes as gender information ‘male’ and age information ‘10s to 20s’.

In addition, the advertisement extractor 230 may register category information of a company that sells women's jewelry as gender information ‘female’ and age information ‘10s to 30s’.

In addition, the advertisement extractor 230 may register category information of a company that sells fashion glasses as age information ‘20s to 30s’ and accessory wearing information ‘glasses’.

Preferably, the advertisement extractor 230 may extract one of a plurality of advertisements as the customized advertisement based on the context match rate and the advertisement cost information of each of the plural advertisements.

Specifically, when there are two or more advertisements whose context match rate exceeds a preset threshold among a plurality of advertisements, the advertisement extractor 230 may extract one advertisement with the highest advertisement rate among the two or more advertisements as the customized advertisement.

For example, if there are 10 advertisements currently uploaded by companies, the advertisement extractor 230 may extract one advertisement with the highest priority as a customized advertisement by sorting a context match rate and calculated advertisement cost (i.e., advertisement cost for one viewing) in ascending order according to the impression of a visitor.

As a more specific example, when a 20s woman visitor wearing glasses presses a bell, the advertisement extractor 230 may select jewelry company advertisements and glasses company advertisements as candidate advertisements based on category information corresponding to a visitor's context information (20s, glasses), and select, as a customized advertisement, an advertisement of a jewelry company having a higher advertisement cost among the selected candidate advertisements.

In accordance with an aspect, the advertisement extractor 230 may select an advertisement with the next highest priority as a customized advertisement when a preset total advertisement cost (i.e., the sum of advertisement costs calculated for each advertisement) of an advertisement with the highest priority is exhausted.

The advertisement provider 240 according to an embodiment may control the extracted customized advertisement to be output to the visitor through the doorbell.

The advertisement system 200 may further include a reward provider for accumulating a reward, which corresponds to a customized advertisement outputted through a doorbell, to a preset account of a resident who has received a call message. For example, the reward provider may be included in the cloud server 130 described with reference to FIG. 1.

In accordance with an aspect, the reward provider may measure a time from when a customized advertisement is played through a doorbell to when the play ends, and accumulate the number of points corresponding to the measured time as a reward to a resident's preset account.

For example, the accumulated reward may be used to purchase apps, ringtones, background images, and the like of a wall pad provided in a resident's residence, but are not limited thereto.

FIG. 3 is a drawing for explaining an advertisement method according to an embodiment.

In other words, FIG. 3 is a drawing for explaining an operation method of the advertisement system according to an embodiment described with reference to FIGS. 1 and 2.

Referring to FIG. 3, in step 310 of the advertisement method, a data collector may collect video data of a visitor corresponding to a call message when the call message is received from a doorbell.

Next, in step 320 of the advertisement method, a context extractor may extract context information through impression analysis based on the collected image data.

In accordance with an aspect, in step 320 of the advertisement method, the context extractor may extract at least one piece of information of visitor's gender information, age information, costume-wearing information, accessory-wearing information, and height information as context information.

For example, in step 320 of the advertisement method, the context extractor may determine age information (e.g., 10s, 20s, 30s, etc.) of a visitor based on a preset age determination algorithm that receives collected image data as an input.

In addition, in step 320 of the advertisement method, the context extractor may determine visitor's gender information (e.g., male or female), costume-wearing information (e.g., suit, casual, etc.), accessory-wearing information (e.g., earrings, necklace, glasses, etc.) and height information (e.g., short and tall, etc.) based on a preset impression discrimination algorithm that receives collected image data as an input.

In addition, in step 320 of the advertisement method, the context extractor may extract appearance information (e.g., hairstyle, mustache, etc.) as context information based on a preset impression discrimination algorithm that receives collected image data as an input.

Next, in step 330 of the advertisement method, the advertisement extractor may extract at least one customized advertisement from among a plurality of pre-stored advertisements based on the extracted context information.

In accordance with an aspect, in step 330 of the advertisement method, the advertisement extractor may calculate a context match rate between pre-stored category information corresponding to each of a plurality of advertisements and the extracted context information, and extract one of the plural advertisements as a customized advertisement based on the calculated context match rate.

For example, the advertisement extractor may collect category information and advertisement cost information corresponding to advertisements from companies registering advertisements in advance and register them together with advertisements.

As a more specific example, in step 330 of the advertisement method, the advertisement extractor may register category information of a company that sells men's basketball shoes as gender information ‘male’ and age information ‘10s to 20s’.

In addition, in step 330 of the advertisement method, the advertisement extractor may register category information of a company that sells women's jewelry as gender information ‘female’ and age information ‘10s to 30s’.

In addition, in step 330 of the advertisement method, the advertisement extractor may register category information of a company that sells fashion glasses as age information ‘20s to 30s’ and accessory wearing information ‘glasses’.

Preferably, in step 330 of the advertisement method, the advertisement extractor may extract one of a plurality of advertisements as a customized advertisement based on a context match rate and advertisement cost information of each of the plural advertisements.

Specifically, in step 330 of the advertisement method, the advertisement extractor may extract one advertisement with the highest advertisement rate among two or more advertisements as a customized advertisement when there are two or more advertisements whose context match rate exceeds a preset threshold among a plurality of advertisements.

For example, in step 330 of the advertisement method, the advertisement extractor may extract one advertisement with the highest priority as a customized advertisement by sorting a context match rate and calculated advertisement cost in ascending order according to the impression of a visitor if there are 10 advertisements currently uploaded by companies.

As a more specific example, in step 330 of the advertisement method, the advertisement extractor may select jewelry company advertisements and glasses company advertisements as candidate advertisements based on category information corresponding to a visitor's context information (20s, glasses), and select, as a customized advertisement, an advertisement of a jewelry company having a higher advertisement cost among the selected candidate advertisements when a 20s woman visitor wearing glasses presses a bell.

In accordance with an aspect, in step 330 of the advertisement method, the advertisement extractor may select an advertisement with the next highest priority as a customized advertisement when a preset total advertisement cost of an advertisement with the highest priority is exhausted.

Next, in step 340 of the advertisement method, the advertisement provider may control the extracted customized advertisement to be output to the visitor through the doorbell.

Next, in step 350 of the advertisement method, a reward provider may accumulate a reward corresponding to a customized advertisement displayed in a preset account of a user who has received a call message.

In accordance with an aspect, in step 350 of the advertisement method, the reward provider may measure a time from when a customized advertisement is played through a doorbell to when the play ends, and accumulate the number of points corresponding to the measured time as a reward to a resident's preset account.

In conclusion, the present disclosure can provide a customized advertisement to a visitor using a doorbell.

In addition, the present disclosure enables a resident to generate a certain amount of revenue by providing the resident with a reward according to the output of a customized advertisement in the form of a point.

In addition, the present disclosure can increase the probability of actual product purchase by a visitor by providing a customized advertisement through analysis of a visitor' impression.

In addition, the present disclosure can provide a customized advertisement more easily by utilizing only a channel change function without changing hardware or software of a previously installed doorbell and wall pad.

In accordance with an aspect, the present disclosure can provide a customized advertisement to a visitor using a doorbell.

In accordance with an aspect, the present disclosure enables a resident to generate a certain amount of revenue by providing the resident with a reward according to the output of a customized advertisement in the form of a point.

In accordance with an aspect, the present disclosure can provide a customized advertisement more easily by utilizing only a channel change function without changing hardware or software of a previously installed doorbell and wall pad.

Although the present disclosure has been described with reference to limited embodiments and drawings, it should be understood by those skilled in the art that various changes and modifications may be made therein. For example, the described techniques may be performed in a different order than the described methods, and/or components of the described systems, structures, devices, circuits, etc., may be combined in a manner that is different from the described method, or appropriate results may be achieved even if replaced by other components or equivalents.

Therefore, other embodiments, other examples, and equivalents to the claims are within the scope of the following claims.

### DESCRIPTION OF SYMBOLS

200: advertisement system 210: data collector
220: context extractor 230: advertisement extractor
240: advertisement provider

What is claimed is:

1. An advertisement system using a doorbell, the advertisement system comprising:
a data collector configured to collect video data of a visitor corresponding to a call message when the call message is received from a doorbell;
a context extractor configured to extract context information through impression analysis based on the collected image data;
an advertisement extractor configured to extract at least one customized advertisement from among a plurality of pre-stored advertisements based on the extracted context information; and
an advertisement provider configured to control the extracted customized advertisement to be displayed to the visitor through the doorbell.

2. The advertisement system according to claim 1, further comprising a reward provider configured to accumulate a reward corresponding to the outputted customized advertisement to a preset account of a resident who received the call message.

3. The advertisement system according to claim 2, wherein the reward provider measures a time from a time point at which the customized advertisement is played through the doorbell to a time point at which the play ends, and accumulates the number of points corresponding to the measured time as a reward.

4. The advertisement system according to claim 1, wherein the context extractor extracts at least one piece of information of gender information, age information, costume-wearing information, accessory-wearing information, and height information of the visitor as the context information.

5. The advertisement system according to claim 1, wherein the advertisement extractor calculates a context match rate between pre-stored category information corresponding to each of the plural advertisements and the extracted context information, and extracts one of the plural advertisements as the customized advertisement based on the calculated context match rate.

6. The advertisement system according to claim 5, wherein the advertisement extractor extracts one advertisement as the customized advertisement based on the context match rate and the advertisement cost information of each of the plural advertisements.

7. The advertisement system according to claim 6, wherein, when there are two or more advertisements whose context match rate exceeds a preset threshold among a plurality of advertisements, the advertisement extractor extracts one advertisement with a highest advertisement rate among the two or more advertisements as the customized advertisement.

8. An advertisement method using a doorbell, the advertisement method comprising:
by a data collector, collecting video data of a visitor corresponding to a call message when the call message is received from a doorbell;
by a context extractor, extracting context information through impression analysis based on the collected image data;
by an advertisement extractor, extracting at least one customized advertisement from among a plurality of pre-stored advertisements based on the extracted context information; and
by an advertisement provider, controlling the extracted customized advertisement to be displayed to the visitor through the doorbell.

9. The advertisement method according to claim 8, further comprising, by a reward provider, accumulating a reward corresponding to the outputted customized advertisement to a preset account of a user who received the call message.

10. The advertisement method according to claim 8, wherein, by the advertisement extractor in the extracting of the at least one customized advertisement, a context match rate between pre-stored category information corresponding to each of the plural advertisements and the extracted context information is calculated, and one of the plural advertisements is extracted as the customized advertisement based on the calculated context match rate.

11. The advertisement method according to claim 10, wherein, by the advertisement extractor, one advertisement is extracted as the customized advertisement based on the context match rate and the advertisement cost information of each of the plural advertisements.
